(19) United States
(12) Patent Application Publication
(10) Pub. No.: US 2011/0105643 A1
(43) Pub. Date: May 5, 2011

(54) POLYMER-ENCAPSULATED NANOPARTICLES

(76) Inventors: Doris Pik-Yiu Chun, Sunnyvale, CA (US); Hou T. Ng, Palo Alto, CA (US)

(21) Appl. No.: 12/608,976

(22) Filed: Oct. 29, 2009

(51) Int. Cl. C08K 9/10; B32B 1/00; C08F 2/44

(52) U.S. Cl. 523/205; 428/407; 524/849; 977/773; 977/774

(57) ABSTRACT

A polymer-encapsulated nanoparticle is disclosed herein. The polymer-encapsulated colorant nanoparticle includes a colorant nanoparticle core, and a polymer coating permanently established on the colorant nanoparticle core via covalent bonding or physical bonding, the polymer coating including in situ polymerized monomers or prepolymers of a discontinuous phase of an inverse emulsion. The polymer-encapsulated colorant nanoparticle has a size ranging from about 20 nm to about 1000 nm.

### BACKGROUND

The present disclosure relates generally to polymer-encapsulated nanoparticles.

Encapsulated particles have become increasingly useful in a variety of biological applications (e.g., drugs, cosmetics, etc.), printing applications (e.g., laser printing, digital commercial printing, etc.), and electronic applications (e.g., electronic inks, light emitting polymers, e-field displays, etc.). Such particles have been produced using a variety of methods often requiring additional tools and/or process steps.

### BRIEF DESCRIPTION OF THE DRAWINGS

Features and advantages of embodiments of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 schematically depicts a polymer-encapsulated nanoparticle according to an embodiment disclosed herein;

FIG. 2 is a flow diagram depicting an embodiment of a method of forming the polymer-encapsulated nanoparticle shown in FIGS. 1; and

FIGS. 3A through 3D together schematically depict an example of a method of forming the embodiment of the polymer-encapsulated nanoparticle shown in FIG. 1.

### DETAILED DESCRIPTION

Embodiment(s) of the polymer-encapsulated nanoparticle disclosed herein include a polymerized coating established on a nanoparticle core. Such a polymer-encapsulated nanoparticle is formed using inverse emulsification, whereby a continuous phase solution is substantially continuously added to a discontinuous phase solution until phase inversion is established (i.e., the continuous phase solution becomes the continuous phase and the discontinuous phase solution become the discontinuous phase). In an example, the polymerization of the monomer(s) or prepolymer(s) in the inverse emulsification may be accomplished in situ (for instance, in a single container) for both water-based and non-water-based nanoparticle systems. This method advantageously reduces the amount of equipment and/or process steps needed to ultimately form the nanoparticle. This renders the process relatively cost effective and efficient in both energy and time. The polymer-encapsulated nanoparticles may advantageously be used as colorant particles for inkjet inks, or other desirable applications.

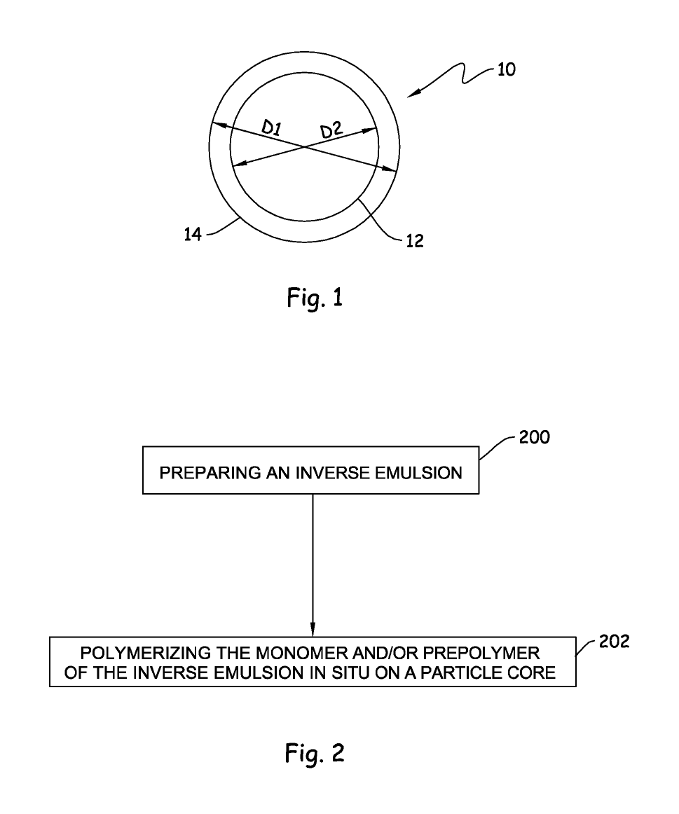

An example of a polymer-encapsulated colorant nanoparticle 10 is schematically depicted in FIG. 1. The nanoparticle 10 generally includes a colorant nanoparticle core 12 encapsulated with a coating 14 formed from polymerized components of an inverse emulsion. The in situ polymerization may, in some instances, form a continuous coating, which covers the entire surface of the nanoparticle core 12. Such continuous coatings may be formed when the contact angle of the monomer and/or the prepolymer on the colorant nanoparticle 10 is less than 80 degrees. Such may be achieved when the surface energy of the polymer (from which the coating is formed) is substantially similar to that of the colorant nanoparticle 10. In other instances, the in situ polymerization may form a discontinuous coating, which covers various portions of the nanoparticle core 12. The discontinuous coating may be achieved, for example, when the surface energy of the polymer is different than that of the colorant nanoparticle 10. In a non-limiting example, the surface energy of the polymer is considered to be different than that of the colorant nanoparticle 10 when the contact angle of the monomer and/or the prepolymer on the colorant nanoparticle 10 is about 80 degrees or more. In some cases, the contact angle ranges from about 80 degrees to about 100 degrees. In other cases, the contact angle ranges from about 80 degrees to about 90 degrees. In still other cases, the surface energies are significantly different when the contact angle of the monomer and/or the prepolymer on the colorant nanoparticle 10 is greater than 100 degrees. Generally, a larger contact angle (and a larger difference between the nanoparticle surface energy and the monomer and/or prepolymer surface energy) will correspond with a more discontinuous coating 14.

The resulting polymer coating 14 forms a shell that houses the nanoparticle core 12. In some instances, the coating 14 is actually permanently established on the nanoparticle core 12. It is to be understood that the term “permanent,” as used in reference to the establishment of the coating 14 on the nanoparticle core 12, refers to non-reversible encapsulation of the nanoparticle core 12 with the coating 14 (i.e., the polymerized monomers and/or prepolymers permanently remain on the surface of the nanoparticle core 12). Such is in contrast to thermodynamically reversible coatings such as, e.g., in self-assembling processes. Such permanent establishment may be accomplished via covalent bonding when one or more components of the inverse emulsion chemically react with the nanoparticle core 12. The polymer coating 14 may otherwise be attached to the nanoparticle core 12 through physical bonding, such as, e.g., through hydrogen bonding, Van der Waals interactions, Zwitterionic interactions, or the like.

The nanoparticle core 12 (i.e., the non-encapsulated colorant nanoparticle) is formed from any suitable nanoparticle including, but not limited to, colorants (e.g., organic pigments, inorganic pigments, or dyes), quantum dots, colloidal particles (e.g., metal colloids), or combinations thereof. The nanoparticles 12 are also spherically/substantially spherically shaped, where each has an initial size (i.e., diameter) D₂ ranging from about 50 nm to about 250 nm. In a non-limiting example, the average size D₂ of the nanoparticle 12 is about 150 nm. It is to be understood, however, that the size of the nanoparticles 12 depends, at least in part, on the material selected for such particles. The size of the polymer-encapsulated nanoparticle 10 (i.e., the nanoparticle core 12 encapsulated with the coating 14 formed via in situ polymerization of one or more components of the inverse emulsion) is less than or equal to 1 micron. In a non-limiting example, the size (i.e., diameter) D₁ of the polymer-encapsulated nanoparticle 10 ranges from about 20 nm to about 1000 nm. In another non-limiting example, the size D₁ of the polymer-encapsulated nanoparticle 10 ranges from about 100 nm to about 250 nm.

The relatively small size of the resulting polymer-encapsulated nanoparticles 10 is particularly suitable for inkjet inks. For example, the encapsulated particles 10 are ink-jettable without considerable misfiring of ink drops during ink ejection from the print head, inaccurate alignment of the firing of the ink drops, and/or deleteriously clogging the print head used. Such advantages may be due, at least in part, to the desired particle size that is achieved when the nanoparticle core 12 is encapsulated via the method(s) disclosed herein.

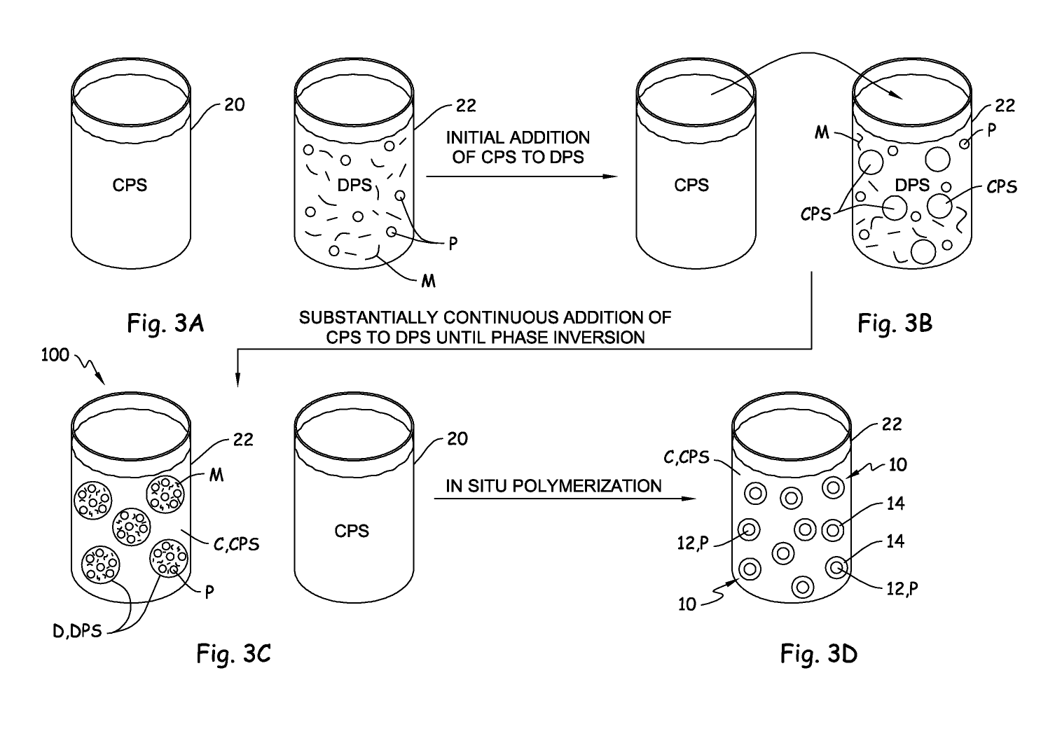

To reiterate from above, the polymer-encapsulated nanoparticle 10 is ultimately formed by polymerizing monomers and/or prepolymers present in a discontinuous phase of an inverse emulsion on the nanoparticle core 12. The inverse emulsion is formed using an inverse emulsification process. An embodiment of such process is described hereinbelow in conjunction with FIG. 2, while a more specific example of the embodiment is schematically illustrated in the FIG. 3 series.

Referring now to FIG. 2, an embodiment of the process or method of forming the polymer-encapsulated nanoparticle 10 includes preparing an inverse emulsion (as shown by reference numeral 200) and then polymerizing at least the monomer and/or prepolymer of the inverse emulsion in situ on the nanoparticle core 12 (as shown by reference numeral 202).

Referring now to the example depicted in the FIG. 3 series, the inverse emulsion (identified by reference numeral 100 in FIG. 3C) may ultimately be prepared by first separately forming a discontinuous phase solution DPS and a continuous phase solution CPS (both shown in FIG. 3A). It is to be understood that the term “solution,” as used herein with reference to the discontinuous phase solution and the continuous phase solution refers to both liquid-based solutions (e.g., solutions having a viscosity of less than about 1000 cP) and solid solutions (e.g., solutions having a viscosity of greater than 1000 cP, which are often considered to be paste-like mixtures). In an example, the discontinuous phase solution DPS is formed in one container 22, while the continuous phase solution CPS is formed in another separate container 20.

As shown between FIGS. 3A and 3B, the continuous phase solution CPS is then substantially continuously added to the discontinuous phase solution DPS until phase inversion is established (as shown in FIG. 3C). During the addition of the continuous phase solution CPS to the discontinuous phase solution DPS, the contents may be stirred. In an example, the continuous phase solution CPS is added to the discontinuous phase solution DPS dropwise, e.g., via an addition funnel or metered pump at a rate of about 0.5 mL/min to about 5 mL/min. In another example, the continuous phase solution CPS is added to the discontinuous phase solution DPS substantially continuously at a rate of about 20 mL/10 min, and the mixing of the discontinuous phase solution DPS and the continuous phase solution CPS is accomplished at a stir rate of less than or equal to 1000 rpm (or, e.g., 700 rpm to 1000 rpm).

As used herein, the term “substantially continuously” refers to the addition of the continuous phase solution CPS to the discontinuous phase solution DPS for an uninterrupted amount of time until phase inversion is established. Such uninterrupted amount of time includes a time frame where no interruptions actually occur, as well as those instances where one or more small interruptions occur (e.g., a 1, 2, or 3 second break in adding the continuous phase solution CPS). Such small interruptions are referred to herein as minor variations from the actual continuous addition of the continuous phase solution CPS to the discontinuous phase solution DPS. Also, it is to be understood that the term “substantially continuously” may be used interchangeably with the term “continuously.”

At the outset of adding the continuous phase solution CPS to the discontinuous phase solution DPS, the discontinuous phase solution DPS is the continuous phase (see, e.g., FIG. 3B). However, upon further addition of the continuous phase solution CPS, phase inversion occurs and the continuous phase solution CPS becomes the continuous phase C, and the discontinuous phase solution DPS becomes the discontinuous phase (as shown in FIG. 3C). The result of phase inversion is the inverse emulsion 100.

Phase inversion often correlates with a significant or noticeable change in conductivity, and the point at which phase inversion occurs may vary depending upon the materials used in the continuous phase solution CPS and the discontinuous phase solution DPS. As one example, if the continuous phase solution CPS is a water-based solution, when the two solutions DPS, CPS are emulsified, phase inversion occurs when there is a jump in the conductivity of the emulsion. This jump in conductivity is due, at least in part, to the fact that water is a conductive material and has become the continuous phase C. In this example, the jump in conductivity may be an increase in conductivity (i.e., the emulsion becomes more conductive). For instance, for a water-based continuous phase solution CPS, phase inversion may be accomplished when the jump in the conductivity of the solution is at least 1 mS/cm. In other examples, the jump in conductivity may be a decrease in conductivity. For instance, for a non-water-based continuous phase solution CPS, phase inversion may be accomplished when the conductivity of the solution is decreased by about 1 μS/cm or less. In some cases, the conductivity jump may be as low as 1 nS/cm.

The FIG. 3 series illustrates the substantially continuous addition of the continuous phase solution CPS to the discontinuous phase solution DPS until phase inversion occurs. As previously mentioned, the inverse emulsion 100 is formed when phase inversion is achieved. The phase inversion may be a catastrophic phase inversion (CPI), which may be achieved by controlling the ratio of water-to-oil or oil-to-water of the water-based solution and the non-water-based solution, respectively. The phase inversion may otherwise be a transitional phase inversion (TPI), which may be achieved by controlling process conditions and/or formulations such as, e.g., temperature and salinity. Either one of the catastrophic phase inversion or the transitional phase inversion may be used so long as the desired particle size is achieved.

Once phase inversion is achieved, polymerization is initiated to generate the polymer-encapsulated nanoparticles 10 (shown in FIG. 3D). The stir rate may also be reduced (e.g., to about or less than 250 rpm) after phase inversion is complete. Polymerization of the monomer(s) and/or prepolymer(s) M in the discontinuous phase solution DPS may be initiated by, and accomplished during heating of the inverse emulsion 100. For a substantially complete polymerization of the monomer(s) and/or prepolymer(s), heating may be accomplished from about 5 hours to about 12 hours. It is to be understood, however, that the heating time depends, at least in part, on polymerization kinetics of the monomer(s) and/or prepolymer(s). For instance, polymerization of a monomer that tends to react quickly in response to heat may require a shorter heating time as compared to another monomer that tends to react more slowly to heat. In a non-limiting example, the heating of the inverse emulsion 100 occurs at a temperature ranging from about 50° C. to about 90° C. In another example, the heating of the inverse emulsion 100 occurs at a temperature ranging from about 50° C. to about 75° C. In yet another example, the heating of the inverse emulsion 100 occurs at a temperature ranging from about 70° C. to about 90° C.

Polymerization then occurs until the polymer coating 14 is formed on the nanoparticle core 12, thereby forming the polymer-encapsulated nanoparticles 10 (as shown in FIG. 3D). In an example, the completeness of the polymerization may be determined using one or more analytical and/or spectroscopic techniques such as, e.g., high performance liquid chromatography (HPLC), gas or liquid chromatography-mass spectrometry (GC/MS or LC/MS), thermogravimetric analysis (TGA), etc. Such techniques may be used, for example, to identify the monomer(s) and/or prepolymer(s), as well as the extent of their polymerization during the heating. Polymerization may thereafter be terminated by exposing the resulting solution (containing the encapsulated particles 10) to a stream of argon gas.

In an embodiment, the inverse emulsion 100 may also be homogenized prior to polymerization (not shown in the FIG. 3 series). Such homogenization may be used to ensure the nanoparticle size and stability of the inverse emulsion 100. In an example, homogenization is accomplished by transferring the inverse emulsion 100 to a microfluidizer, and then subjecting the emulsion 100 to a predetermined pressure for a predetermined number of cycles. The inverse emulsion 100 may otherwise be homogenized in the microfluidizer for a particular amount of time, which depends, at least in part, on the emulsion volume. In a non-limiting example, the emulsion 100 inside the microfluidizer is subjected to a shearing pressure of about 20 psi for a number of cycles ranging from 2 to 5 and is processed at a rate of about 250 mL/min. Thereafter, the homogenized inverse emulsion 100 is transferred back to the reaction container 22, where the inverse emulsion 100 is subjected to stirring and then to thermal initiation of the polymerization reaction.

It is to be understood that the inverse emulsion 100 may be prepared from either a water-based nanoparticle system or a non-water-based nanoparticle system. For water-based nanoparticle systems, the inverse emulsion 100 is formed by introducing a water-based continuous phase solution CPS to a non-water-based discontinuous phase solution DPS until the phases invert. This inverse emulsification process results in the nanoparticles 10 formed an aqueous based continuous phase C. For non-water-based nanoparticle systems, the inverse emulsion 100 is formed by introducing a non-water-based continuous phase solution CPS to a water-based discontinuous phase solution DPS until the phases invert. This inverse emulsification process results in the nanoparticles 10 formed in a non-aqueous based continuous phase C.

Regardless of whether the inverse emulsion 100 is formed from a water-based nanoparticle system or a non-water-based nanoparticle system, it is to be understood that none of the resulting phases C or D include a fluorinated material. Such fluorinated materials may deleteriously affect the polymerization of the monomer(s) and/or the prepolymer(s). In many cases, fluorinated materials may react with and quench radicals (such as, e.g., halocarbons) present in the continuous phase solution CPS, thereby potentially and undesirably prematurely terminating polymerization of the monomer(s) and/or prepolymer(s). Such may result in a relatively poor encapsulation of the monomer(s) and/or prepolymer(s) on the nanoparticle core 12.

When the continuous phase solution CPS is water-based, the medium may be any aqueous medium selected from water (deionized or degassed), or a mixture of water and another aqueous solvent, such as a glycol, a glycol ether, or an alcohol (e.g., an alcohol selected from the DOWANOL™ series (The Dow Chemical Company, Midland, Mich.), isopropanol, etc.). In one embodiment, the continuous phase solution CPS is formed at least from dionized or degassed water. The amount of water present in the continuous phase solution CPS ranges from 400 mL to about 1000 mL.

In another embodiment, the continuous phase solution CPS is formed from water and at least one surfactant dissolved in the water. In an example, the surfactant(s) are selected from nonionic surfactants, anionic surfactants, or combinations thereof. Some non-limiting examples of anionic surfactants that may suitably be used for a water-based continuous phase solution CPS include sulfates (such as, e.g., sodium dodecyl sulfate (SDS) and sodium laureth sulfate (SLS), TRITON® XN-45S, TRITON® W-30, and TRITON® QS-15 (The Dow Chemical Company)), sulfonates (such as, e.g., DOWFAX® 2A1, DOWFAX® 3B2, DOWFAX® 8390, DOWFAX® 30599, and TRITON® X-200K (all from The Dow Chemical Company), sulfosuccinates (such as, e.g., AEROSOL OT® (CYTEC Industries, Inc., Woodland Park, N.J.) and TRITON® GR-5M and TRITON® 7M (The Dow Chemical Company)), and geminal disulfonates (such as, e.g., those selected from the DOWFAX™ series (The Dow Chemical Company)). Some non-limiting examples of nonionic surfactants include ethylene oxide, polyacids, polyamines, polyurethanes, polyesters, and polyether polyols, polyethylene ethers (such as, e.g., TERGITOL® (The Dow Chemical Company), BRIJ® (Croda International, PLC, England), and LUTENSOL® (BASF Corporation, Ludwigshafen, Germany)). For instance, about 1 wt % to about 10 wt % of an anionic surfactant and from about 1 wt % to about 10 wt % of a nonionic surfactant may be used in the water-based continuous phase solution CPS, where the selection of such surfactants is accomplished in order to achieve a desired hydrophile lipophile balance (HLB) for the resulting inverse emulsion 100. The surfactant(s) may otherwise be selected from cationic surfactants alone. Some non-limiting examples of suitable cationic surfactants include cationic surfactants of the SOLSPERSE® series (Lubrizol Advanced Materials, Inc., Wickliffe, Ohio) such as, e.g., SOLSPERSE® 9000, SOLSPERSE® 17000, and SOLSPERSE® 19000.

In some cases, the continuous phase solution CPS includes a water-based solvent (such as water) and at least one of a surfactant, a dispersant, or an initiator. Without being bound to any theory, it is believed that the initiator present in the continuous phase solution CPS diffuses into the discontinuous phase solution DPS and replaces radicals of the discontinuous phase solution DPS that are consumed during the polymerization reaction. Further, some non-limiting examples of suitable dispersants include sodium dodecyl sulfate (SDS), TERGITOL® 15-S-30 (The Dow Chemical Company) and AEROSOL OT® (CYTEC Industries, Inc.). Some non-limiting examples of suitable initiators include azobisisobutyronitrile (AIBN) for the discontinuous phase solution DPS, and potassium persulfate (KPS) for the continuous phase solution CPS.

When a water-based continuous phase solution CPS is used, the discontinuous phase solution DPS is prepared as a non-aqueous based solution. For a non-water-based discontinuous phase solution DPS, the medium selected may be any non-aqueous based medium having dispersed therein i) a monomer or a prepolymer (identified by the reference character M in FIG. 3A), and ii) colorant nanoparticles (identified by reference character P in FIG. 3A). Generally, the discontinuous phase solution DPS includes from about 10 mL to about 100 mL of the monomers or prepolymers M and about 5 g to about 50 g of the colorant nanoparticles P.

The monomer or the prepolymer M included in the non-aqueous based discontinuous phase solution DPS may be selected from suitable hydrophobic materials. Non-limiting examples of hydrophobic monomers include styrenes (e.g., styrene, methylstyrene, vinylstyrene, dimethylstyrene, chlorostryene, dichlorostyrene, tert-butylstyrene, bromostyrene, and p-chloromethylstyrene), monofunctional acrylic esters (e.g., methyl acrylate, ethyl acrylate, isopropyl acrylate, n-butyl acrylate, butoxyethyl acrylate, isobutyl acrylate, n-amyl acrylate, isoamyl acrylate, n-hexyl acrylate, octyl acrylate, decyl acrylate, dodecyl acrylate, octadecyl acrylate, benzyl acrylate, phenyl acrylate, phenoxyethyl acrylate, cyclohexyl acrylate, dicyclopentanyl acrylate, dicyclopentenyl acrylate, dicyclopentenyloxyethyl acrylate, tetrahydrofurfuryl acrylate, isobornyl acrylate, isoamyl acrylate, lauryl acrylate, stearyl acrylate, benhenyl acrylate, ethoxydiethylene glycol acrylate, methoxytriethylene glycol acrylate, methoxydipropylene glycol acrylate, phenoxypolyethylene glycol acrylate, nonylphenol EO adduct acrylate, isooctyl acrylate, isomyristyl acrylate, isostearyl acrylate, 2-ethylhexyl diglycol acrylate, and oxtoxypolyethylene glycol polypropylene glycol monoacrylate), monofunctional methacrylic esters (e.g., methyl methacrylate, ethyl methacrylate, isopropyl methacrylate, n-butyl methacrylate, i-butyl methacrylate, tert-butyl methacrylate, n-amyl methacrylate, isoamyl methacrylate, n-hexyl methacrylate, 2-ethylhexyl methacrylate, lauryl methacrylate, tridecyl methacrylate, stearyl methacrylate, isodecyl methacrylate, octyl methacrylate, decyl methacrylate, dodecyl methacrylate, octadecyl methacrylate, methoxydiethylene glycol methacrylate, polypropylene glycol monomethacrylate, benzyl methacrylate, phenyl methacrylate, phenoxyethyl methacrylate, cyclohexyl methacrylate, tetrahydrofurfuryl methacrylate, tert-butylcyclohexyl methacrylate, behenyl methacrylate, dicyclopentanyl methacrylate, dicyclopentenyloxyethyl methacrylate, and polypropylene glycol monomethacrylate), allyl compounds (e.g., allylbenzene, allyl-3-cyclohexane propionate, 1-allyl-3,4-dimethoxybenzene, allyl phenoxyacetate, allyl phenylacetate, allylcyclohexane, and allyl polyvalent carboxylate), unsaturated esters of fumaric acid, maleic acid, itaconic acid, etc., and radical polymerizable group-containing monomers (e.g., N-substitued maleimide and cyclic olefins).

Non-limiting examples of suitable hydrophobic prepolymers include low molecular weight (e.g., where the molecular weight is less than 1000 and the viscosity is less than 300 cP) acrylic oligomers such as, e.g., polyethylene-co-acrylic acid, polystyrene-co-polyhexylacrylate, and polyethylene-co-methacrylic acid. Examples of suitable hydrophobic prepolymers also include copolymers of any of the monomers provided above.

Examples of suitable colorant nanoparticles (which make up the nanoparticle core 12 in FIG. 1) include, but are not limited to colorants (e.g., organic pigments, inorganic pigments, etc.), quantum dots, colloidal particles (e.g., metal colloids), or combinations thereof. Non-limiting examples of the colorant nanoparticles include carbon black pigment particles (such as, e.g., XPB-306 and Printex 25 (Evonik Degussa Corporation, Parsippany, N.J.)), blue pigment particles (such as, e.g., BASF D7079 (BASF Corporation)), titanium dioxide particles, ferric oxide particles, and cadmium selenide particles.

The medium of the non-water-based discontinuous phase solution DPS includes, in an embodiment, at least one surfactant and at least one oil-soluble radical initiator.

Without being bound to any theory, it is believed that the amount and/or the type of the surfactant(s) incorporated in the discontinuous phase solution DPS affects the particle size of the resultant polymer-encapsulated nanoparticles 10. More specifically, by controlling the amount and/or the type of the surfactant to be added to the discontinuous phase solution DPS, the particle size of the polymer-encapsulated nanoparticle 10 may be controlled. In general, the surface area of a particle tends to increase with decreasing emulsion volume. Thus, smaller-sized particles tend to have a much larger surface area-to-volume ratio than larger-sized particles. For instance, for two identical volumes of oil-in-water emulsions, the volume containing less surfactant generally yields particles having larger sizes, while the volume containing more surfactant generally yields particles having smaller sizes. If the volume includes more surfactant than required to stabilize a finite volume of oil, the oil tends to split in order to create more surfaces for the surfactant. For such reasoning, emulsions having higher surfactant concentrations tend to include smaller-sized particles.

Some non-limiting examples of non-water-soluble radical initiators include diazo initiators (such as, e.g., azobis(isobutylnitrile) (AIBN), azobis-(cyclohexane-carbonitrile), and azobis-(2-methylproponitrile)), oil-soluble azo initiators (such as those manufactured by Wako Pure Chemical Industries, Ltd. (e.g., V-65, V-601, and V-59)), and peroxide initiators (such as, e.g., benzoyl-peroxide, LUPEROX® (Arkema, Inc., Colombes, France), and cumene hydroperoxide.

In a non-limiting example, the non-water based discontinuous phase solution DPS may be formed by dissolving the non-water-soluble radical initiator and the at least one surfactant in the monomer or the prepolymer M to form a mixture. In an example, the surfactant may be selected from one or more of the same surfactants that is/are used for the non-water-based continuous phase. Examples of the surfactants for the non-water-based continuous phase are provided hereinbelow. The colorant particles P are then added to the mixture.

When the continuous phase solution CPS is non-water-based, the medium selected may be any non-aqueous media including dielectric media, non-oxidative water immiscible media (e.g., petroleum distillates), or other organic solvent media. In one non-limiting example, the non-aqueous media is an isoparaffinic hydrocarbon (such as those in the ISOPAR® series available from Exxon Mobil Corp., Houston, Tex.). In other non-limiting examples, the non-aqueous media includes linear, branched, or cyclic hydrocarbons (such as n-hexanes, heptanes, octane, cyclohexane, dodecane) or mixtures thereof, soy bean oil, vegetable oil, or plant extracts. The non-water-based continuous phase solution CPS may also include an oil-soluble surfactant, such as dioctyl sulfosuccinate, AEROSOL OT® (CYTEC Industries, Inc.), TRITON® GR-5M (The Dow Chemical Company), and surfactants of the SOLSPERSE® series (Lubrizol Advanced Materials, Inc.).

In instances where the inverse emulsion 100 is formed using the non-water-based continuous phase solution CPS, the discontinuous phase solution DPS is prepared as a water-based solution formed from a water-based medium having dispersed therein i) a monomer or a prepolymer M, and ii) colorant nanoparticles P. More specifically, the water-based discontinuous phase solution DPS is formed by dissolving a water-soluble radical initiator and at least one water-soluble surfactant with the monomer or the prepolymer M and the particles P to form a mixture. Non-limiting examples of the water-soluble radical initiator include azobis-(4-cyanovaleric acid), potassium persulfate, ammonium persultate, and water-soluble azo initiators manufactured by Wako Pure Chemical Industries, Ltd. (e.g., V-50 and V-060). Furthermore, non-limiting examples of the surfactant for the water-based discontinuous phase include sodium dodecyl sulfate, DOWFAX™ 2A1 and TERGITOL® 15-S-30 (both from The Dow Chemical Company).

In this embodiment, the discontinuous phase solution D again includes from about 10 mL to about 100 mL of the monomers or prepolymers M and about 5 g to about 50 g of the colorant nanoparticles P.

The colorant nanoparticles P incorporated in the water-based discontinuous phase solution DPS may be selected from the same colorant nanoparticles used for the non-water-based discontinuous phase solution DPS described above.

The monomer and the prepolymer M, on the other hand, are selected from suitable hydrophilic materials. Some non-limiting examples of hydrophilic monomers include an acid containing radical polymerizable monomers such as, e.g., acrylic acid, methacrylic acid, acrylamide, methacrylamide, hydroxyethyl-methacrylate (HEMA), and ethylene-oxide-base methacrylates (PEGMA). A non-limiting example of a hydrophilic prepolymer includes ethylene oxide based urethane prepolymers (e.g., VERSATHANE® 1090, Air Products and Chemicals, Inc., Allentown, Pa.).

The embodiments of the method disclosed hereinabove in conjunction with FIGS. 2, 3A-3D may be used to form the polymer-encapsulated nanoparticles 10 having the desired nanoparticle size without using additional processing steps such as, e.g., an extra dispersion step. It is to be understood that, in some instances, it may be desirable to include an extra dispersion step after phase inversion has been achieved in order to further reduce the size of the nanoparticles 10, if desired.

Furthermore, the embodiment(s) of the polymer-encapsulated nanoparticle 10 may be used as a colorant in inkjet applications. For such applications, the nanoparticles may be filtered (e.g., screened through aluminum sieves) to remove any undesirably large particles and the remaining continuous phase solution CPS. Then the polymer-encapsulated nanoparticles 10 may be incorporated into the formulation of an inkjet ink. In an example, the inkjet ink includes a vehicle, which itself is made up of about 12 wt % of a solvent, about 3 wt % of at least one surfactant, and the balance being water. In some instances, the vehicle may also include additives such as, e.g., biocides, binders, and/or the like. About 5 wt % of the total wt % of the ink is the polymer-encapsulated nanoparticles 10, which are dispersed in the vehicle. The inkjet ink may, in an example, be monitored to maintain a pH between 7.5 and 8.5. In instances where the pH drops below this range, a 1M solution of potassium hydroxide may be added to the ink to raise the pH to the desired level.

To further illustrate embodiment(s) of the present disclosure, the following examples are given herein. It is to be understood that these examples are provided for illustrative purposes and are not to be construed as limiting the scope of the disclosed embodiment(s).

### EXAMPLES

For all of the following examples, the discontinuous and the continuous phases are prepared separately (e.g., in separate containers). The first container (referred to herein as the reaction vessel) was initially charged with the discontinuous phase solution, and then the continuous phase solution was added thereto at a fixed rate until phase inversion occurred.

### Example 1

A water-based continuous phase solution was prepared by dissolving 450 mL of 0.9 wt % sodium dodecyl sulfate (SDS) in dionized water and degassed water in a 3-neck, 1 L reaction vessel equipped with a mechanical stirrer and a reflux condenser. A discontinuous phase solution was prepared in a separate container by dissolving 5 g of IGEPAL® co520, 4 g of AERSOL® OT, and 1g of azobis(isobutyronitrile) (AIBN) in 50 g of (50:50) styrene/hexylmethacrylate. Thereafter, 15 g of XPB-306 carbon black was gradually added to the discontinuous phase solution while stirring.

The water-based continuous phase solution was then added to the discontinuous phase solution at a rate of 20 mL/10 min at 700 rpm to 1000 rpm. Phase inversion occurred when a significant change in the solution conductivity was measured (i.e., when the conductivity increased from mS/cm to the order of nS/cm until no significant change in conductivity was detected). The solution was then transferred to a MICROFLUIDIZER® (model 110-Y with an 87 micron interaction chamber) and homogenized at an internal sheer pressure of 20 psi. The solution cycled through 3 cycles and was then collected back into the reaction vessel. In the reaction vessel, the solution was then stirred at a reduced stirring speed of 250 rpm and the reaction vessel was subjected to external heating via a heating mantle to 75° C. under a stream of argon gas for 6 to 8 hours. The product included polystyrene/hexylmethacrylate encapsulated carbon black particles.

### Example 2

A water-based continuous phase solution was prepared by providing 450 mL of dionized water and degassed water in a 3-neck, 1 L reaction vessel equipped with a mechanical stirrer and a reflux condenser. A discontinuous phase solution was prepared in a separate container by dissolving 5 g of IGEPAL® co520, 6 g of AERSOL® OT, and 1g of AIBN in 50 g in (50:49:1) styrene/hexylmethacrylate/ethylene glycol dimethacrylate. Thereafter, 15 g of BASF D 7079 cyan 15:3 pigments was gradually added to the discontinuous phase solution while stirring.

The water-based continuous phase was then added to the discontinuous phase solution at a rate of 20 mL/10 min at 700 rpm to 1000 rpm. Phase inversion occurred when a significant change in the solution conductivity was measured (i.e., when the conductivity increased from mS/cm to the order of nS/cm until no significant change in conductivity was detected). The solution was then transferred to a MICROFLUIDIZER® (model 110-Y with an 87 micron interaction chamber) and homogenized at an internal sheer pressure of 20 psi. The solution cycled through 3 cycles and was then collected back into the reaction vessel. Thereafter, the stirring speed was reduced to 250 rpm and the reaction vessel was subjected to external heating via a heating mantle to 75° C. under a stream of argon gas for 6 to 8 hours. The product included polystyrene/hexylmethacrylate encapsulated cyan particles.

### Example 3

A water-based continuous phase solution was prepared by dissolving 0.75 wt % SDS in 450 mL of dionized water and degassed water in a 3-neck, 1 L reaction vessel equipped with a mechanical stirrer and a reflux condenser. A discontinuous phase solution was prepared in a separate container by dissolving 5 g of IGEPAL® co520 and 6 g of AERSOL® OT in 50 g of (70:30) VERSATHANE®1090/toluene diisocyanate (TDI) and 1g of toluene diisocyanate. Thereafter, 15 g of BASF D 7086 cyan 15:3 pigments was gradually added to the discontinuous phase solution while stirring.

The water-based continuous phase was then added to the discontinuous phase solution at a rate of 20 mL/10 min at 700 rpm to 1000 rpm. Phase inversion occurred when a significant change in the solution conductivity was measured (i.e., when the conductivity increased from mS/cm to the order of nS/cm until no significant change in conductivity was detected). The solution was then transferred to a MICROFLUIDIZER® (model 110-Y with an 87 micron interaction chamber) and homogenized at an internal sheer pressure of 20 psi. The solution cycled through 3 cycles and was then collected back into the reaction vessel. Thereafter, the stirring speed was reduced to 250 rpm and the reaction vessel was subjected to external heating via a heating mantle to 50° C. for 6 to 8 hours. The product included polyurethane/urea encapsulated cyan particles.

### Example 4

A water-based continuous phase solution was prepared by dissolving 0.75 wt % SDS in 400 mL of dionized water and degassed water in a 3-neck, 1 L reaction vessel equipped with a mechanical stirrer and a reflux condenser. A discontinuous phase solution was prepared in a separate container by dissolving 5 g of IGEPAL® co520 and 6 g of AERSOL® OT in 50 g of (70:30) VERSATHANE®1090/TDI. Thereafter, 15 g of BASF D 7086 cyan 15:3 pigments was gradually added to the discontinuous phase solution while stirring.

The water-based continuous phase was then added to the discontinuous phase solution at a rate of 20 mL/10 min at 700 rpm to 1000 rpm. Phase inversion occurred when a significant change in the solution conductivity was measured (i.e., when the conductivity increased from mS/cm to the order of nS/cm until no significant change in conductivity was detected). The solution was then transferred to a MICROFLUIDIZER® (model 110-Y with an 87 micron interaction chamber) and homogenized at an internal sheer pressure of 20 psi. The solution cycled through 3 cycles and was then collected back into the reaction vessel. Thereafter, the stirring speed was reduced to 250 rpm and the reaction vessel was subjected to external heating via a heating mantle to 50° C. for 6 to 8 hours. The product included polyurethane/urea encapsulated cyan particles.

### Example 5

A non-water-based continuous phase solution was prepared by dissolving 0.75 wt % SDS in 450 mL of 0.5 wt % SOLSPERSE® 19000 in ISOPAR® V in a 3-neck, 1 L reaction vessel equipped with a mechanical stirrer and a reflux condenser. A discontinuous phase solution was prepared in a separate container by dissolving 5 g of IGEPAL® co720, 6.3 g of TRITON® GR5M (59%), and 1 g of 4,4′-Azobis(4-cyanovaleric acid) and in 50 g of (2:2:1) methylmethacrylate (MMA)/hydroxyethyl-methacrylate/acrylamide. Thereafter, 15 g of carboxylated carbon black was gradually added to the discontinuous phase solution while stirring.

The non-water-based continuous phase solution was then added to the discontinuous phase solution at a rate of 20 mL/10 min at 700 rpm to 1000 rpm. Phase inversion occurred when a significant change in the solution conductivity was measured (i.e., when the conductivity increased from mS/cm to the order of nS/cm until no significant change in conductivity was detected). The solution was then transferred to a MICROFLUIDIZER® (model 110-Y with an 87 micron interaction chamber) and homogenized at an internal sheer pressure of 20 psi. The solution cycled through 3 cycles and was then collected back into the reaction vessel. Thereafter, the stirring speed was reduced to 250 rpm and the reaction vessel was subjected to external heating via a heating mantle to 75° C. under a stream of argon gas for 6 to 8 hours. Upon cooling, the product included poly methane arsonic acid/hydroxyethyl-methacrylate/acrylamide encapsulated carbon black particles.

While several embodiments have been described in detail, it will be apparent to those skilled in the art that the disclosed embodiments may be modified. Therefore, the foregoing description is to be considered exemplary rather than limiting.

What is claimed is:

1. A polymer-encapsulated colorant nanoparticle, comprising:
a colorant nanoparticle core; and
a polymer coating established on the colorant nanoparticle core via covalent bonding or physical bonding, the polymer coating including in situ polymerized monomers or prepolymers of a discontinuous phase of an inverse emulsion;
wherein the polymer-encapsulated colorant nanoparticle has a size ranging from about 20 nm to about 1000 nm.

2. The polymer-encapsulated colorant nanoparticle as defined in claim 1 wherein a continuous phase of the inverse emulsion is a non-water-based solution, and wherein the monomers are selected from acid containing radical polymerizable monomers.

3. The polymer-encapsulated colorant nanoparticle as defined in claim 2 wherein an acid of the acid containing radical polymerizable monomers is selected from acrylic acid, methacrylic acid, acrylamides, methacrylamides, hydroxyethyl-methacrylates, ethylene-oxide-base methacrylates, and combinations thereof.

4. The polymer-encapsulated colorant nanoparticle as defined in claim 1 wherein a continuous phase of the inverse emulsion is a water-based solution, and wherein the monomers are selected from styrene derivatives, monofunctional acrylic esters, monofunctional methacrylic esters, allyl compounds, unsaturated esters of fumaric acid, radical polymerizable group-containing monomers, and combinations thereof.

5. The polymer-encapsulated colorant nanoparticle as defined in claim 1 wherein the colorant nanoparticles are selected from pigment particles, quantum dots, colloidal particles, and combinations thereof.

6. The polymer-encapsulated colorant nanoparticle as defined in claim 1 wherein the continuous phase includes a solvent and at least one of a surfactant, a dispersant, or an initiator.

7. The polymer-encapsulated colorant nanoparticle as defined in claim 1 wherein the prepolymers are selected from an acrylic oligomer having a molecular weight less than about 1000 and a viscosity less than about 300 cP.

8. The polymer-encapsulated colorant nanoparticle as defined in claim 1 wherein the polymer coating is permanently established on the colorant nanoparticle.

9. A method of forming polymer-encapsulated nanoparticles, comprising:
preparing an inverse emulsion by substantially continuously adding a continuous phase solution to a discontinuous phase solution until a phase inversion is established and the continuous phase solution becomes a continuous phase of the inverse emulsion, the continuous phase solution including one of a non-water-based solution or a water-based solution, each of the non-water-based solution and the water-based solution including a material other than a fluorinated material, and the discontinuous phase solution including a mixture of at least i) a monomer or a prepolymer, and ii) colorant nanoparticles; and
polymerizing at least the monomer or the prepolymer of the inverse emulsion in situ to form a coating on the surface of the colorant nanoparticles.

10. The method as defined in claim 9 wherein the coating is established on the surface of the colorant nanoparticles by covalent bonding or physical bonding between the polymerized monomer or prepolymer and the colorant particles.

11. The method as defined in claim 9 wherein the preparing of the inverse emulsion includes:
forming the discontinuous phase solution and the continuous phase solution, the forming of the discontinuous phase solution being accomplished separately from the forming of the continuous phase solution;
adding the continuous phase solution to the discontinuous phase solution to form a mixture, the adding being accomplished at a rate of about 20 mL/10 min at a stir rate ranging from about 700 rpm to about 1000 rpm; and
achieving the phase inversion when a conductivity of the mixture changes and the discontinuous phase solution becomes a discontinuous phase in the continuous phase solution.

12. The method as defined in claim 9 wherein upon achieving the phase inversion, the method further includes:
reducing the stir rate to about 250 rpm;
heating the inverse emulsion to initiate the polymerization; and
exposing the inverse emulsion to a stream of argon gas to terminate polymerization.

13. The method as defined in claim 12 wherein the heating of the inverse emulsion is accomplished at a temperature ranging from about 50° C. to about 75° C.

14. The method as defined in claim 11 wherein the inverse emulsion is a water-based emulsion, and wherein the discontinuous phase solution is formed by:
dissolving a non-water-soluble radical initiator and at least one surfactant in the monomer to form a mixture; and
adding the colorant particles to the mixture.

15. The method as defined in claim 14 wherein the continuous phase solution is formed from i) water, or ii) at least one other surfactant dissolved in water.

16. The method as defined in claim 11 wherein the inverse emulsion is a non-water-based emulsion, and wherein the discontinuous phase solution is formed by:
dissolving a water-soluble radical initiator and at least one surfactant with the monomer to form a mixture; and
adding the colorant particles to the mixture.

17. The method as defined in claim 16 wherein the continuous phase is formed by dissolving a non-water-soluble surfactant in an isoparaffinic hydrocarbon.

18. The method as defined in claim 9 wherein the discontinuous phase further includes at least one surfactant, and wherein the method further comprises controlling a particle size of the polymer-encapsulated nanoparticles by controlling at least one of an amount or a type of the at least one surfactant.

19. The method as defined in claim 9 wherein the continuous phase solution includes at least one surfactant selected from anionic surfactants and nonionic surfactants, and wherein the amount of the at least one surfactant ranges from about 0.5 wt % to about 30 wt %.

20. An inkjet ink, comprising:
a vehicle, including:
a solvent;
at least one surfactant; and
water; and
polymer-encapsulated colorant nanoparticles dispersed in the vehicle, the polymer-encapsulated colorant nanoparticles including:
a colorant nanoparticle core; and
a polymer coating established on the colorant nanoparticle core via covalent bonding or physical bonding, the polymer coating including in situ polymerized monomers or prepolymers of a discontinuous phase of an inverse emulsion;
wherein the polymer-encapsulated colorant nanoparticle has a size ranging from about 20 nm to about 1000 nm.
